(19) United States
(12) Patent Application Publication
(10) Pub. No.: US 2014/0014856 A1
(43) Pub. Date: Jan. 16, 2014

(54) Biosensor

(71) Applicants: Timothy Ingram Cox, Worcester (GB); John Lock, Malvern (GB); Brian James Perrett, Malvern (GB); Rachel Patricia Tuffin, Chandlers Ford (GB)

(72) Inventors: Timothy Ingram Cox, Worcester (GB); John Lock, Malvern (GB); Brian James Perrett, Malvern (GB); Rachel Patricia Tuffin, Chandlers Ford (GB)

(73) Assignee: QINETIQ LIMITED, Hampshire (UK)

(21) Appl. No.: 14/008,174

(22) PCT Filed: Mar. 30, 2012
(86) PCT No.: PCT/GB12/00293

§ 371 Date: Sep. 27, 2013

(30) Foreign Application Priority Data
Mar. 30, 2011 (GB) 1105335.2

(51) Int. Cl. G01N 21/64

(52) U.S. Cl. CPC G01N 21/6486
USPC 250/459.1; 250/458.1; 250/576; 250/227.11

(57) ABSTRACT

Optical sensors comprising a fluidic channel through which fluid carrying magnetised beads may be passed, an optical source for illuminating fluid as is passes through the channel, a sensor for detecting fluorescence emitted by the beads when illuminated by the optical source, and magnet means arranged to temporarily capture and retain the magnetic beads at an assay point in the fluidic channel illuminated by the optical source and monitored by the sensor. Methods and further apparatus relating to the same.

### FIELD OF THE INVENTION

The present invention relates to apparatus and methods of measuring levels of chemical markers in fluids in general and biomarkers in bodily fluids such as saliva in particular and systems incorporating the same.

### BACKGROUND TO THE INVENTION

It is known to measure the presence of bio-markers or other chemicals in a fluid (e.g. a liquid) using chemically functionalised magnetic beads. The beads are coated with recognition agents (e.g. antibodies, aptamers, or short chain peptides) selected to target a chemical (e.g. biomarker) of interest. When the beads are placed in the fluid of interest, the recognition agents capture the biomarkers within the fluid. The beads are subsequently washed with a solution containing recognition agents labelled with a fluorescent tag (i.e. a fluorophore) which selectively binds to the chemical of interest previously captured on the beads. When illuminated these fluorophores emit light of a different and characteristic wavelength which may then be taken as indicative of the presence of the chemical of interest. The intensity of the fluorescence may then be used as a measure of the concentration of the chemicals of interest in the fluid. This is known as a sandwich assay since a sandwich is formed of a capture antibody (attached to the bead), the marker of interest and the detection antibody which is tagged with the fluorophore. The number of sandwiches formed then depends on the concentration of the marker.

Whilst the method described above employs a fluorescent spot on each marker other methods of producing light might also be utilised, for example, a detection (top) antibody could be labelled with an enzyme, for example horse radish peroxidise (HRP). The enzyme could then react with a chemical either to produce a fluorescent dye or to actually emit light by chemiluminescence. Methods in which an enzyme is involved are known as Enzyme-Linked Immunosorbent Assays (ELISA) or Enzyme Immunoassay (EIA). An advantage of such methods is that a single enzyme tag can react with many dye molecules or chemiluminescent molecules. These approaches are well known to those skilled in the art.

The enzyme or recognition agent can also be selected to react with a colourless molecule to produce a coloured one. The presence of the coloured molecule can then be detected by absorption spectroscopy which can also be measured in the proposed optical arrangement.

Such markers are known to be used when testing serum in which the concentration of biomarkers of interest may be relatively high (e.g. micrograms per ml) and conventional assay techniques can be used. The conventional approach is often ELISA based. However for measurement of, for example, biomarkers in saliva the concentrations are of the order of nanograms per ml or lower. Thus the detection approach and associated instrumentation for analysis of saliva using the assay based on the fluorescent sandwich needs to be quite sophisticated. This currently typically involves use of a large and expensive confocal microscope. Such bulky components are impractical for a hand-held or consumer-operated instrument.

It is known from “Rapid fabrication of a microfluidic device with integrated optical waveguides for DNA fragment analysis” by Bliss et al. (Lab on a Chip, Volume 7, October 2007, pages 1280-1287) to input and collect light via liquid filled waveguides, the optical waveguides being separated from a fluidic channel by means of thin optically transparent windows.

### OBJECT OF THE INVENTION

The invention seeks to provide improved methods and apparatus for chemical and biochemical assay of fluids.

### SUMMARY OF THE INVENTION

According to a first aspect of the present invention there is provided an optical sensor comprising a fluidic channel through which fluid carrying magnetised beads may be passed, an optical source for illuminating fluid as is passes through the channel, a sensor for detecting fluorescence emitted by the beads when illuminated by the optical source, and magnet means arranged to temporarily capture and retain the magnetic beads at an assay point in the fluidic channel illuminated by the optical source and monitored by the sensor.

Although referred to here as magnetic beads, the beads are in fact really magnetisable as they have no intrinsic magnetisation. They are preferably superparamagnetic—a large magnetic moment being induced in a magnetic field—but this disappears when the magnetic field is reduced.

The sensor may also comprise pump means arranged to pump fluid through the fluidic channel.

The sensor may also comprise valves to control fluid flow and other microfluidic components such as filters to remove particulates or materials which might interfere with the chemical detection process.

The sensor may also comprise an optical fibre located in a first optical channel.

The monitoring means may comprise an optical fibre in a second optical channel.

The sensor may also comprise a third optical channel arranged to carry away light from the light source reflected from the assay point.

At least one of the optical channels may comprise fibre locating means arranged to facilitate location of the end of the respective optical fibre nearest the assay point within the fluidic channel.

The optical channels may be sealed against the fluidic channel whereby to prevent fluid entering the optical channels.

The light source may produce, simultaneously or successively, light at a plurality of predetermined wavelengths selected to cause fluorescence of chemicals coating the surface of some or all of the magnetic beads.

The assay point may be substantially at least one of smooth and straight whereby to facilitate flushing of the assay point after use.

The magnet means may comprise a magnet and a magnetic concentrator having a rounded focus end.

The magnet means may comprise a spherical magnet.

The magnet may be mounted in a rotatable mount arranged to facilitate movement of the magnet away from the assay point whereby to release the magnetic beads.

Advantageously, the amount of magnetic flux entering the magnetic concentrator is small when the mount is rotated to position the magnet at 90 degrees to the main axis of the magnetic concentrator. Furthermore the magnetic flux entering the magnetic concentrator decreases rapidly as the mount is rotated.

The invention also provides for a system for the purposes of sensing which comprises one or more instances of apparatus embodying the present invention, together with other additional apparatus.

The invention is also directed to methods by which the described apparatus operates and including method steps for carrying out every function of the apparatus.

In particular according to a further aspect of the present invention there is provided a method of sensing comprising providing an optical sensor comprising a fluidic channel having an assay region located at the convergence of an excitation channel and a collection channel with the fluidic channel, the method comprising the steps of: magnetically trapping magnetic sandwich assay beads in the assay region; exciting the trapped beads by illuminating them with light via the excitation channel; monitoring light received from the beads via the collection channel.

The preferred features may be combined as appropriate, as would be apparent to a skilled person, and may be combined with any of the aspects of the invention.

### BRIEF DESCRIPTION OF THE DRAWINGS

In order to show how the invention may be carried into effect, embodiments of the invention are now described below by way of example only and with reference to the accompanying figures in which:

FIG. 1 shows a schematic diagram of a sensing system in accordance with the present invention;

FIG. 2 shows a schematic diagram of a first sandwich assay method in accordance with the present invention;

FIG. 3 shows a second sandwich assay method in accordance with the present invention;

FIG. 4 shows a schematic graph of spectral response in accordance with the present invention;

FIG. 5 shows a perspective view of sensor apparatus in accordance with the present invention;

FIG. 6 shows a schematic diagram of a portion of a sensor in accordance with the present invention;

FIG. 7 shows a schematic view of illumination within a sensor in accordance with the present invention;

FIG. 8 shows a schematic diagram of magnet means within a sensor in accordance with the present invention.

### DETAILED DESCRIPTION OF INVENTION

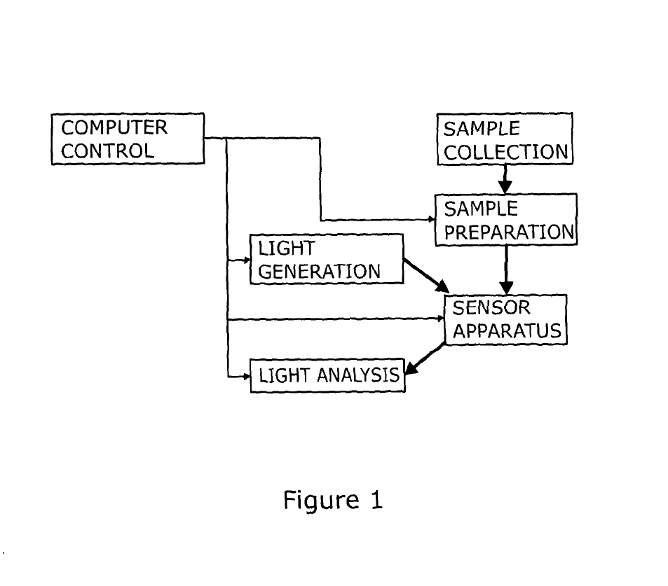

Referring to FIG. 1 a method of detecting and measuring concentration of chemicals within a fluid comprises the steps of:
Collecting a sample of the fluid of interest (e.g. saliva);
Preparing the sample for analysis by:
   mixing the fluid with reagents coated on sandwich assay magnetic beads;
   providing fluorophores attached to a recognition agent to bind to the chemical of interest captured on the beads;
Performing an assay in a sensor apparatus by:
   concentrating the magnetic beads together in an assay region;
   illuminating the coated beads in the assay region whereby to elicit fluorescence from the fluorophores bound to the chemical of interest captured on the beads;
   deriving a measure of the presence and concentration of the chemical of interest by measuring the fluorescence emitted from the coated beads.

As noted above other forms of assay may be used (e.g. ELISA chemiluminescence etc.)

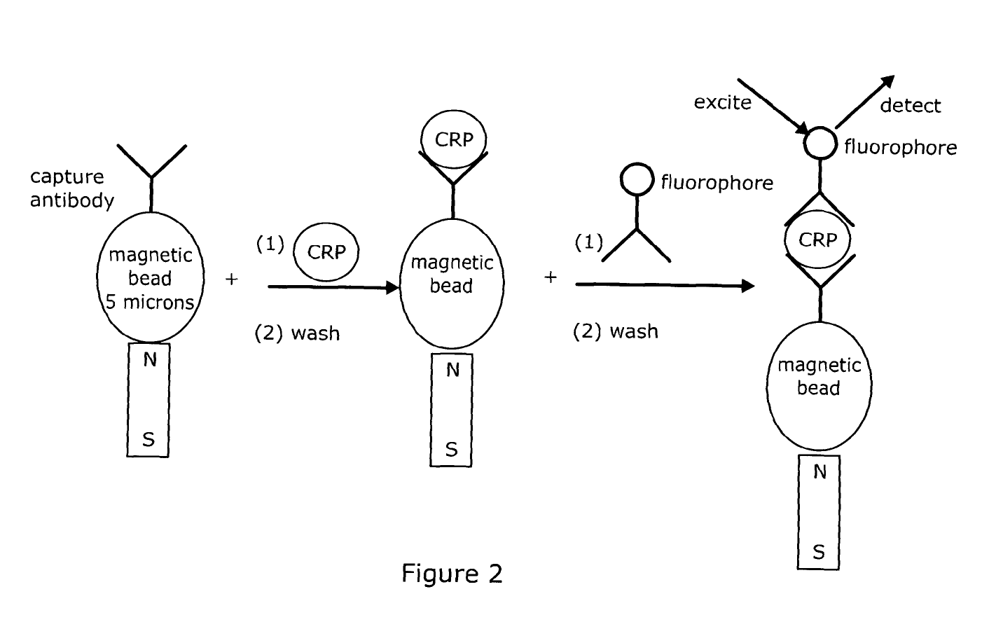

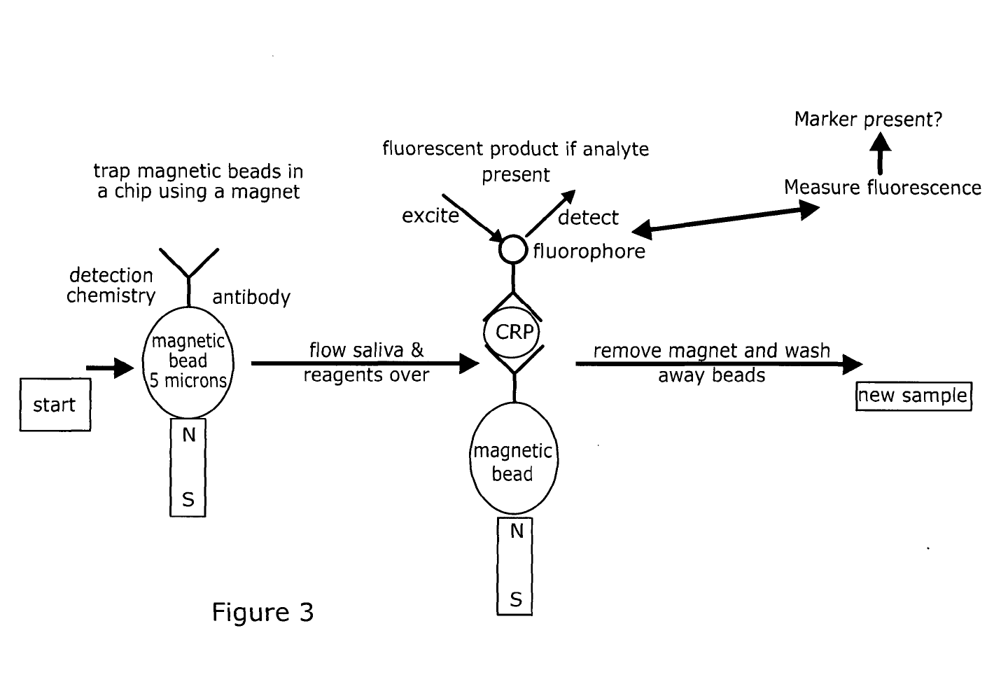

Referring now to FIGS. 2 and 3 the approach adopted is to carry out the required chemistry on the surface of small magnetic beads (e.g. 4.5 micron diameter). The bead diameter is preferably in the range 100 nm to 6 microns or any subrange thereof, and more preferably 300 nm to 2 microns.

The assay is a sandwich assay in which a fluorescent species is created at the end of the assay and the intensity of the fluorescence is then related to the concentration of the chemical marker to which it refers.

Washing steps are performed in order to remove firstly unbound CRP and secondly unbound fluorophore. This is achieved by trapping the beads, and unbound fluorophore may then be washed away. Alternatively a single washing step may be performed to remove both unbound CRP and fluorophore.

Alternatively the beads may be trapped at the start of the process and then reagents flowed over the beads, followed by a washing solution.

The assay may use commercially available antibodies as recognition agents for the markers of interest. One of the aspects to be tackled is the production of a false positive signal: i.e. a positive signal in the absence of the marker. This is often referred to as non-specific binding. A variety of reagents may be used to ‘block’ the surface to prevent non-specific binding. Such techniques are known to those skilled in the art and are particular to the markers and antibodies of interest.

Several different markers can be measured simultaneously by using a collection of beads which are coated with capture antibodies for the different markers, along with corresponding fluorophores. To allow analysis of these analytes, excitation and detection of fluorescence at different wavelengths may be used, either simultaneously or successively.

In addition, a known number of beads with a known level of intrinsic fluorescence may be added to the collection of detection beads to act as a calibrant for the fluorescence intensity. The fluorophore might be a quantum dot or an organic dye fluorophore. This allows compensation to be applied dynamically for any fluctuation due for example to variation in laser intensity or variation in opacity of the fluid at the assay region.

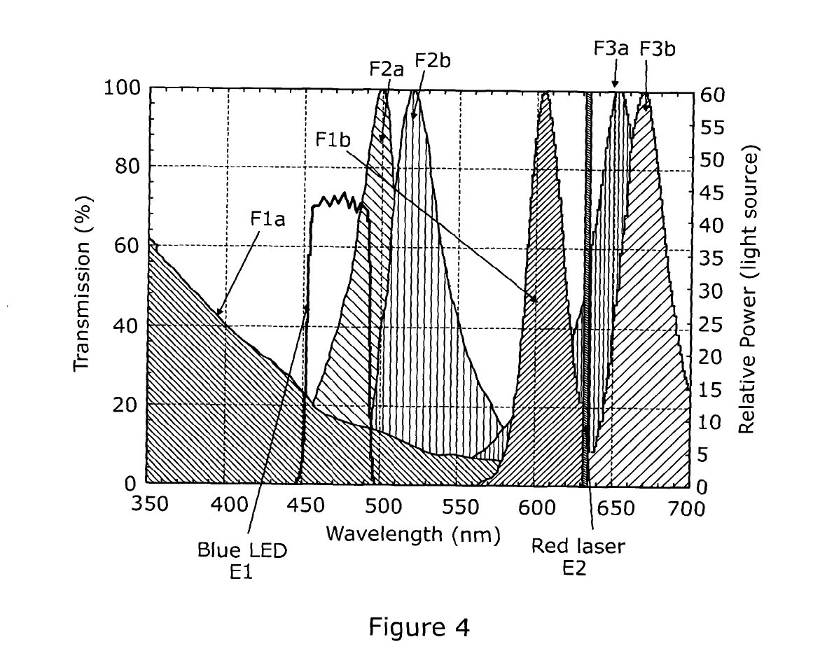

Referring now to FIG. 4 it is important to distinguish fluorescence from the different fluorophores so that they can be individually measured. A dye has two important characteristics: its absorption spectrum (i.e. the absorption as a function of wavelength) and its emission spectrum (i.e. the emission as a function of wavelength). So, for example, for a given fluorophore exciting at a first wavelength (e.g. 480 nm) allows the presence of the fluorophore may be detected by emissions at a distinct wavelength (e.g. 520 nm).

Thus by tuning the excitation and detection wavelength it is possible to distinguish between a number of fluorophores by choosing dyes having excitation and detection wavelengths which allow a number of marker molecules to be measured. For example three fluorophores may be used:
for a first fluorophore F1 curve F1a gives the excitation spectrum, whilst curve F1b gives the emission spectrum.
for a second fluorophore F2 curve F2a gives the excitation spectrum, whilst curve F2b gives the emission spectrum.
for a third fluorophore F3 curve F3a gives the excitation spectrum, whilst curve F3b gives the emission spectrum.

It is then possible to excite fluorophores using a blue LED having a square emission profile E1 in conjunction with a red laser E2. Thus there is no, or minimal, overlap of emission spectra from F1, F2 and F3 when excited by the two light sources.

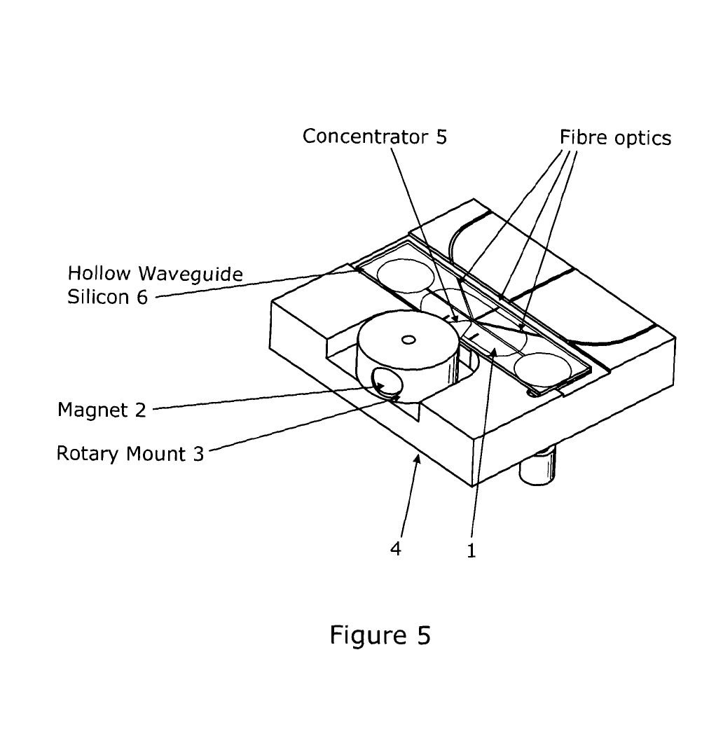

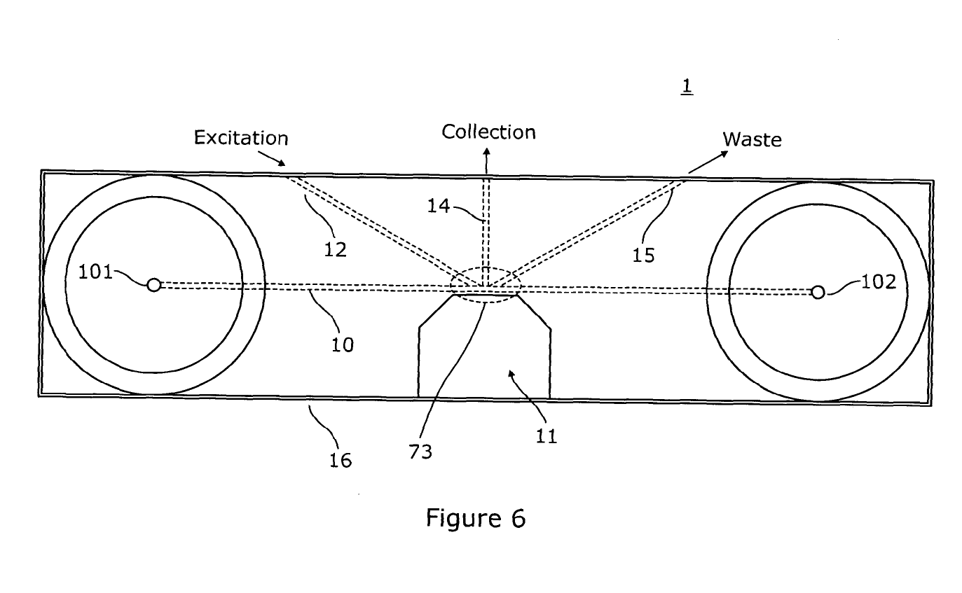

Referring now to FIGS. 5 and 6, a sensor apparatus for comprises a sensor system 1 mounted in a chassis block 4 and a magnet 2 on a rotating solenoid 3 mounted on the chassis block adjacent the assay region 73 of the sensor system.

The integrated sensor system 1 comprises a substrate 16 in which is formed a fluidic channel 10 along which the magnetic beads and reagents may be flowed from an entry fluidics nano-port 101 to an exit nano-port 102. A micro-magnetic assembly 11 is provided to concentrate the beads at an assay region located in the fluidics channel. An optical sub-system performs the following functions:
conducts excitation light to the area of interest along a first optical waveguide 12 to illuminate the assay region;
conducts fluorescence (or any other light) which might be generated as a result of the excitation away along a second optical waveguide 14;
conducts reflected excitation light away along a third optical waveguide 15.

The optical waveguides may conveniently be optical fibres located in slots in the substrate.

The fluidic channel may include additional functions such as a dimensional filter (e.g. a wier or frit) to trap or exclude particles of a particular size. Beads may also be trapped in the fluidic flow path by the wier—reagents may then be flowed through the beads—thereby offering an efficient interaction of the beads with the reagents.

The fluidic input is via nanoport 101 which is a standard micro-fluidic component. It is attached to the chip 16 and allow the connection of standard micro-fluidic tubing to the chip whereby to conduct the fluid to the chip.

Excitation light is conducted to the assay region along an optical waveguide 12 and any reflected light is conducted away via a second optical waveguide 15. At least some light from fluorescent emissions from beads concentrated within the illuminated assay region are conducted away by means of a further optical waveguide 14.

Although the channels may be configured in other ways (e.g. channel 12 may be used to excite and channel 15 to collect fluorescence) using 12 to excite and 14 to detect gives improved efficiency of rejection of the excitation wavelength, particularly if the surface of the fluidic channel 10 is reflective at the assay region. The patch of beads produces a rough surface so it is not reflective, or at least less reflective than such a fluidic channel surface.

Magnetic beads are ideally localised in the assay region at the common field of view of the excitation and fluorescence collection waveguides.

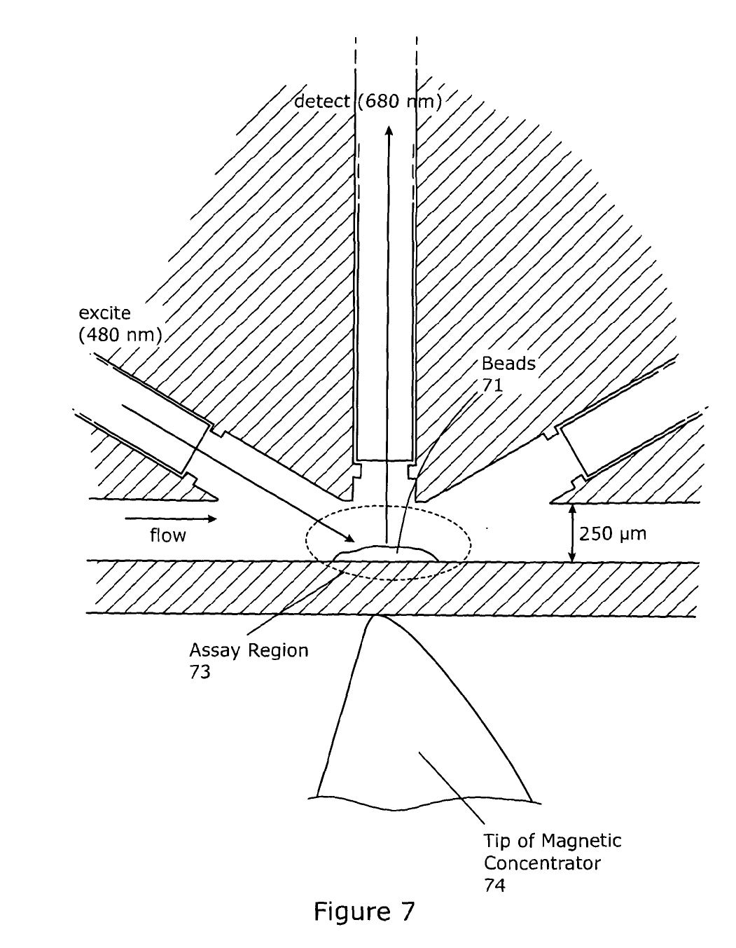

Referring additionally to FIG. 7, the fluidics channel is formed by etching a slot into a silicon wafer using deep reactive ion etching. Alternatively the fluidic channel may be milled, At the same time the slots may also be milled or etched to take the optic fibres. The slot depth of 250 microns is convenient for the optical fibres as this is a few tens of microns deeper than the optic fibres; conveniently the same slot depth and width of 250 microns may also be used for the fluidic channel though other dimensions are possible. A glass lid is bonded to the top of the slot structure to form enclosed channels for the passage of fluids and to hold the fibres.

Other optical fibre of other diameters may be used: however a 250 micron channel gives a good flow rate and is not too prone to blockage and also allows the use of a 220 micron fibre in slots of the same size as the fluidic channel.

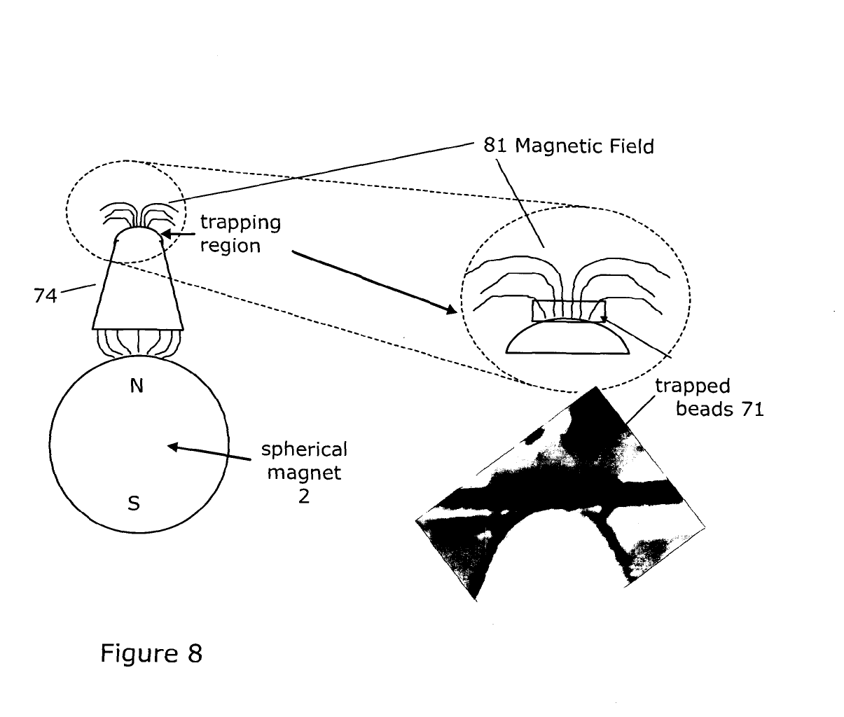

Referring to FIG. 8, the micro-magnetic means concentrates a patch of magnetic beads in the fluidic channel at the tip of the magnetic concentrator.

Referring again to FIG. 7, the guide channel for the optical fibre has a constriction 72 which reduces the channel to a width to less than that of the diameter of optical fibre. For example, if the fibre has a diameter of 220 microns, the channel width is 250 microns then the channel width may be reduced to 200 microns at the constriction. In assembly, the fibre is inserted into the guide channel until it locates firmly against the constriction. UV curable glue is then allowed to wick into the fibre guide. The passage of the glue is observed using a microscope. Just as the glue reaches the constriction, UV illumination is turned on. This causes the glue to cure and become more viscous. This stops the passage of the glue into the chip. The continued application of the UV then completes the curing process. In this way, it is possible to form a seal around the fibre which both holds the fibre in place and forms a fluidic seal.

Referring still to FIG. 7, the function of the optics is to excite fluorescence on the surface of the beads 71 and to collect that fluorescence in the most efficient way whilst also rejecting the exciting light itself as well if at all possible. The assay region 73 ends of the exciting fibre and collecting fibre are located as close to each other as conveniently possible so as to maximise both the illumination efficiency to excite the fluorescence and the collection efficiency of emitted fluorescence.

Light emerging from the end of the excitation fibre may be reflected on the sides of the portion of the channel between the fibre end and the fluidic channel. This arrangement gives efficient excitation and collection of fluorescence in a relatively cheap and compact device.

Referring now to FIG. 8, the magnetic beads 71 are trapped by the magnetic field in the chip in the assay region where the fluorescence is measured. An important parameter involves the product of the magnetic field and the magnetic field gradient since this is related to the force on the magnetic bead and thus determines the ability of the magnet to retain the beads as a fluid is flowed past them.

The pole piece of a magnet is placed close to a magnetic concentrator 74. The end of the concentrator remote from the magnet is preferably substantially pointed. The concentrator is preferably made from a material of high permeability so that magnetic flux lines are concentrated in this material. The flux lines are thus brought very close together at the point region of the concentrator adjacent the assay region 73 of the fluidic channel. At this location, both the magnetic field and the magnetic field gradient are high. Thus beads are trapped and concentrated in the assay region.

Conveniently a spherical magnet may be used. Spherical magnets have their poles effectively localised at two points on the circumference diametrically opposite each other. In operation one pole of the magnet is abutted to the magnetic concentrator. This arrangement has been found to work well and produces good concentration of beads in the assay region.

To release the beads, the magnetic field/field gradient must be removed from the assay region. For a permanent magnet, this may be achieved by moving the magnet's pole away from the concentrator or, in the case of an electromagnet, turning off the current to the magnet. Conveniently the magnet maybe mounted on a rotatable mount 3 operated by a solenoid to move the magnet away from the concentrator.

It has been found that using a tapered concentrator with a rounded tip provides better results than a sharply pointed concentrator. A concentrator with a rounded tip is advantageous for producing a nicely distributed patch of beads along the fluidic channel wall within the assay region rather than a more localised mound of beads produced by a sharply pointed concentrator.

The optical set-up has been used to localise magnetic beads for the measurement of fluorescence on their surface.

The optical set up also offers efficient excitation of fluorescence for materials in the channel, e.g. a dye or dyed molecule/species in the channel.

The magnetic particles may also conveniently have a silver reflective coating on their surface. Such surfaces are known to give a large Surface Enhanced Raman effect (SERS). Thus the platform might be used for the measurement of SERS signals.

It is well known that when certain molecules bind to certain metal surfaces (e.g. silver) their Raman effect is enhanced by several orders of magnitude. Detection reactions can result in such molecules becoming bound to the silver surface. Detection by the SERS effect can thereby increase the sensitivity (i.e. limit of detection) of an assay. The SERS process is further enhanced if the silver particles are of a particular size. Such particles could be prepared on the surface of magnetic beads.

Silver nanoparticles may be prepared in situ in the fluidic microchannel. These particles can then interact with an analyte in the channel. The SERS of such particles could be interrogated by the optical arrangements described above as they are flowed through the assay region. The SERS signal can then give a measure of the concentration of the analyte in the channel.

Whilst the embodiments described above show only optical fibres in the sensor system, other additional optical components can also be integrated on the chip. The hollow waveguide approach offers a convenient basis for accurately and cheaply integrating components:

additional slots can be etched or milled into the substrate into which optical components can then be slotted. Such components may include small optical filters, multiplexers, optical splitters, and wavelength demultiplexers. Such components may be used to facilitate combination of excitation light from different sources and separation of fluorescence or other collected light at different wavelengths. The fact that such optical components can be small also means that they can be very cheap as compared with larger commercially available components which are relatively expensive.

The channels may conveniently be etched in silicon, but they may also be made in a variety of other materials as would be apparent to the skilled person (e.g. a polymer). These could conveniently be formed, for example, by casting the polymer chip against a silicon master.

The system can also be used for flow cytometry, in which particles are flowed through the chip and interrogated for their optical properties (e.g. fluorescence) as they flow through the detection zone.

Any range or device value given herein may be extended or altered without losing the effect sought, as will be apparent to the skilled person for an understanding of the teachings herein.

1. An optical sensor comprising a fluidic channel through which fluid carrying magnetised beads may be passed, an optical source for illuminating fluid as it passes through the channel, a sensor for detecting fluorescence emitted by the beads when illuminated by the optical source, and magnet means arranged to temporarily capture and retain the magnetic beads at an assay region in the channel illuminated by the optical source and monitored by the sensor.

2. A sensor according to claim 1 comprising pump means arranged to pump fluid through the fluidic channel.

3. A sensor according to claim 1 in which the light source comprises an optical fibre located in a first optical channel.

4. A sensor according to claim 3 in which the monitoring means comprises an optical fibre in a second optical channel.

5. A sensor according to claim 4 comprising a third optical channel arranged to carry away light from the light source reflected from the assay point.

6. A sensor according to claim 3 in which the optical channel comprises fibre locating means arranged to facilitate location of the end of the respective optical fibre nearest the assay region within the channel.

7. A sensor according to claim 3 in which the optical channel is sealed against the fluidic channel whereby to prevent fluid entering the optical channel.

8. A sensor according to claim 1 in which the light source produces, simultaneously or successively, light at a plurality of predetermined wavelengths selected to cause fluorescence of chemicals coating the surface of at least some of the magnetic beads.

9. A sensor according to claim 1 in which the assay region is substantially at least one of smooth and straight whereby to facilitate flushing of the assay region after use.

10. A sensor according to claim 1 in which the magnet means comprises a magnet and a magnetic concentrator having a rounded focus end.

11. A sensor according to claim 1 in which the magnet means comprises a spherical magnet.

12. A sensor according to claim 10 in which the magnet is mounted in a rotatable mount arranged to facilitate movement of the magnet away from the assay region whereby to release the magnetic beads.

13. A method of sensing comprising providing an optical sensor comprising a fluidic channel having an assay region located at the convergence of an excitation channel and a collection channel with the fluidic channel, the method comprising the steps of:
magnetically trapping magnetic sandwich assay beads in the assay region;
exciting the trapped beads by illuminating them with light via the excitation channel;
monitoring light received from the beads via the collection channel.

14-15. (canceled)
